(19) United States
(12) Patent Application Publication
(10) Pub. No.: US 2025/0248328 A1
(43) Pub. Date: Aug. 7, 2025

(54) ROTARY CUTTERS AND SUSPENSION SYSTEMS

(71) Applicant: Alamo Group Inc., Seguin, TX (US)

(72) Inventor: Shawn Gray, Selma, AL (US)

(21) Appl. No.: 18/433,028

(22) Filed: Feb. 5, 2024

(51) Int. Cl. A01D 34/66; B60G 3/14

(52) U.S. Cl. CPC A01D 34/661; B60G 3/14; B60G 2300/04

(57) ABSTRACT

A suspension system for a flex-wing rotary cutter may include separate suspension assemblies positioned, respectively, between each of a plurality of wheels and an associated axle upon which a given wheel is mounted. The suspension system may further include a central suspension assembly connecting a central deck and a central axle. The suspension system may provide significantly improved impact load distribution providing a much-improved experience for an operator as compared with some other systems including only suspension assemblies coupled to individual wheels or only a central suspension assembly.

### CROSS REFERENCE TO RELATED APPLICATIONS

None.

### FIELD

This disclosure generally relates to suspension systems for rotary cutters, such as flex-wing rotary cutters.

### BACKGROUND

This section is intended to provide a background or context to the invention that is recited in the claims. The description herein may include concepts that could be pursued but are not necessarily ones that have been previously conceived or pursued. Therefore, unless otherwise indicated herein, what is described in this section is not prior art to the description and claims in this application and is not admitted to be prior art by inclusion in this section.

On rotary cutters, there is typically a suspension system that is used to isolate one or more cutting decks from impact-related stress caused by ground and tire interactions. A suspension system may include one or more suspension components such as a steel spring or elastic material, for example. A suspension component may, for example, be positioned between each of the wheels of a rotary cutter and an associated axle upon which a given wheel may be mounted. These suspension components may reduce impact loading by increasing the time over which a load is applied. For example, an applied load may be distributed over an extended period of time as the suspension component extends and/or contracts over a range of travel in response to the applied load.

Rotary cutters of a flex-wing type generally have some particular constraints when designing a suspension system. Flex-wing rotary cutters typically include a central cutting deck and one or more side cutting decks or wings hinged to the central cutting deck. When a flex-wing rotary cutter is being transported, the central cutting deck is typically raised to some extent in a generally horizontal position, and the one or more side decks are folded upwards into a generally vertical transport configuration. For example, FIG. 8 shows an exemplary embodiment of a flex-wing rotary cutter in a transport configuration. In the transport configuration, only tires connected to the central cutting deck may be in contact with the ground. Furthermore, because the side decks are folded upwards and the central deck is raised to enhance ground clearance, the center of gravity of the rotary cutter may be shifted upwards. If a flex-wing rotary cutter is being transported on a hillside, the rotary cutter may become unstable. This problem may be augmented when using suspension components such as rubber isolators or springs that extend and/or contract over an extended range of travel when absorbing contact loads. For example, if a suspension component associated with one wheel moves upwards when responding to a ground obstacle and another wheel is shifted downwards along its range of travel, the center of gravity of the rotary cutter may shift thereby increasing risk that the rotary cutter may topple or roll over. Accordingly, to minimize risk of rollover, a range of travel allowed for suspension elements may be limited. Stated differently, suspension components which may be coupled to the wheels of a flex-wing rotary cutter may be made fairly stiff so as to prevent excessive motion that may cause instability during transit. Unfortunately, this constraint may limit the ability of the suspension to effectively absorb shock loads.

It would be advantageous to provide a suspension system for a flex-wing rotary cutter that allows for increased stability during transport (e.g., when the cutter is arranged in a transport position with the outer wings folded) without compromising the system's ability to reduce impact loading.

### SUMMARY

In some embodiments, a flex-wing rotary cutter may include a central deck connected to a central axle, a first axle arm depending from the central axle, a first suspension assembly pivotably connected to the first axle arm, the first suspension assembly including: a first suspension bar connected to a first wheel; and a first suspension component flexibly engaged with the first suspension bar and the first axle arm, the first suspension component being configured to resist rotation of the first suspension bar with respect to the first axle arm. The cutter may also include a second axle arm depending from the central axle, a second suspension assembly pivotably connected to the second axle arm, the second suspension assembly including: a second suspension bar connected to a second wheel, and a second suspension component flexibly engaged with the second suspension bar and the second axle arm, the second suspension component being configured to resist rotation of the second suspension bar with respect to the second axle arm. The cutter may further include a side deck hingedly connected to the central deck and also connected to a side axle, a third axle arm depending from the side axle, a third suspension assembly pivotably connected to the third axle arm, the third suspension assembly including: a third suspension bar connected to a third wheel, and a third suspension component flexibly engaged with the third suspension bar and the third axle arm, the third suspension component being configured to resist rotation of the third suspension bar with respect to the third axle arm. The cutter may further include at least one cutting element operably mounted to each of the central deck and the side deck. The cutter may further include a central suspension assembly flexibly connected between the central axle and the central deck, the central suspension assembly including a fourth suspension component configured to mitigate dynamic loads transmitted from the central axle to the central deck.

In some embodiments, a rotary cutter may include a central deck having a rotary cutting element and a central axle rotatably mounted to the central deck. A plurality of axle arms may depend from the central axle. A plurality of suspension bars may be pivotably mounted to respective ones of the plurality of axle arms, a plurality of wheels respectively mounted to the plurality of suspension bars. A plurality of suspension components may be respectively engaged with respective ones of the plurality of axle arms and the plurality of suspension bars such that each of the plurality of suspension components is configured to resist rotation of the respective suspension bar with respect to the respective axle arm. The rotary cutter may further include a central suspension assembly including a central suspension component configured to resist rotation of the central axle with respect to the central deck.

### BRIEF DESCRIPTION OF THE DRAWINGS

FIG. 1 is a top plan view of an exemplary embodiment of a flex-wing rotary cutter hitched to a powered vehicle.

FIG. 2 is a perspective view of the flex-wing rotary cutter of FIG. 1.

FIG. 3 is a detailed perspective view of an exemplary embodiment of an axle arm and a suspension assembly connected thereto.

FIG. 4 is a cross-sectional view of the axle arm of FIG. 3 taken at section 4-4 shown therein.

FIG. 5 is a perspective exploded view of the axle arm shown in each of FIG. 3 and FIG. 4.

FIG. 6 is a detailed perspective view of a part of the flex-wing rotary cutter of FIG. 1 showing an exemplary embodiment of a suspension assembly.

FIG. 7 is an exploded perspective view of the suspension assembly and surrounding components of the flex-wing rotary cutter of FIG. 1.

FIG. 8 is a perspective view of the flex-wing rotary cutter of FIG. 1 in a transport configuration.

### DETAILED DESCRIPTION

As used herein, the following terms should be understood to have the indicated meanings:

When an item is introduced by “a” or “an,” it should be understood to mean one or more of that item.

“Comprises” means includes but is not limited to.

“Comprising” means including but not limited to.

“Having” means including but not limited to.

This disclosure is directed to flex-wing rotary cutters including a suspension system configured for reducing the up and down motion caused by collisions between the tires of the cutter and ground obstacles, providing a more even cut, and reducing high shock loads being transmitted to the cutter and towing vehicle. In some embodiments, the suspension systems described herein may further be configured to improve the stability of flex-wing rotary cutters when the cutters are being towed in a transport configuration over uneven ground.

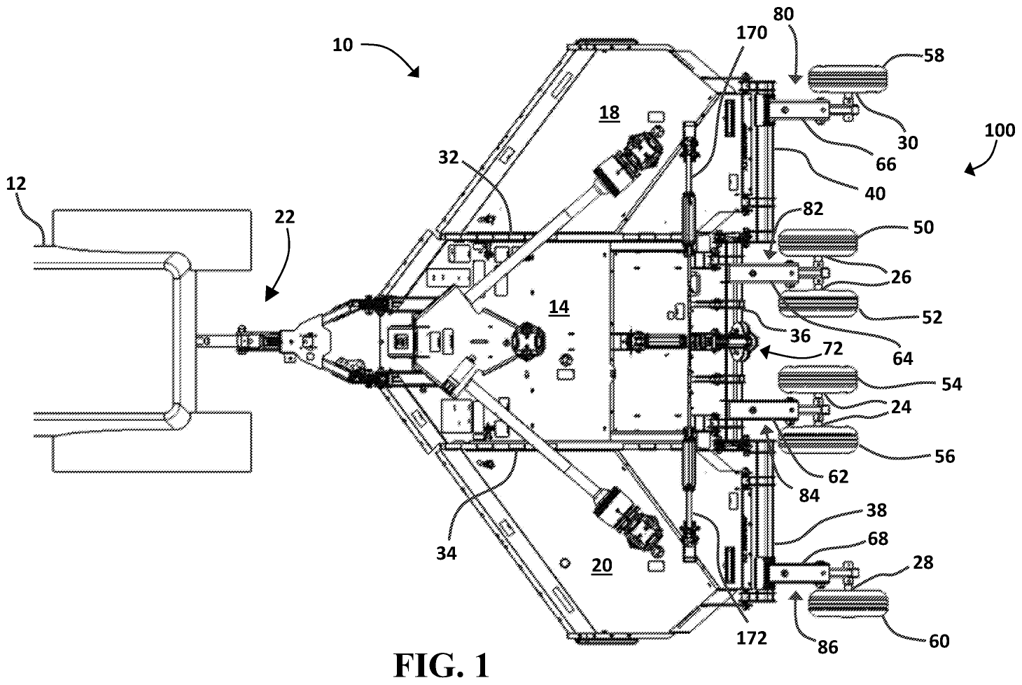

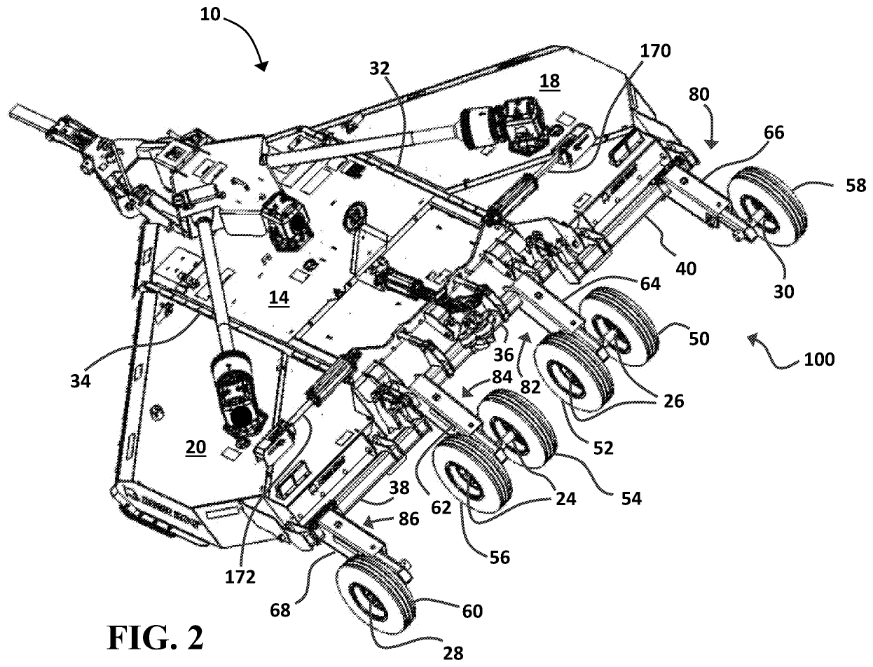

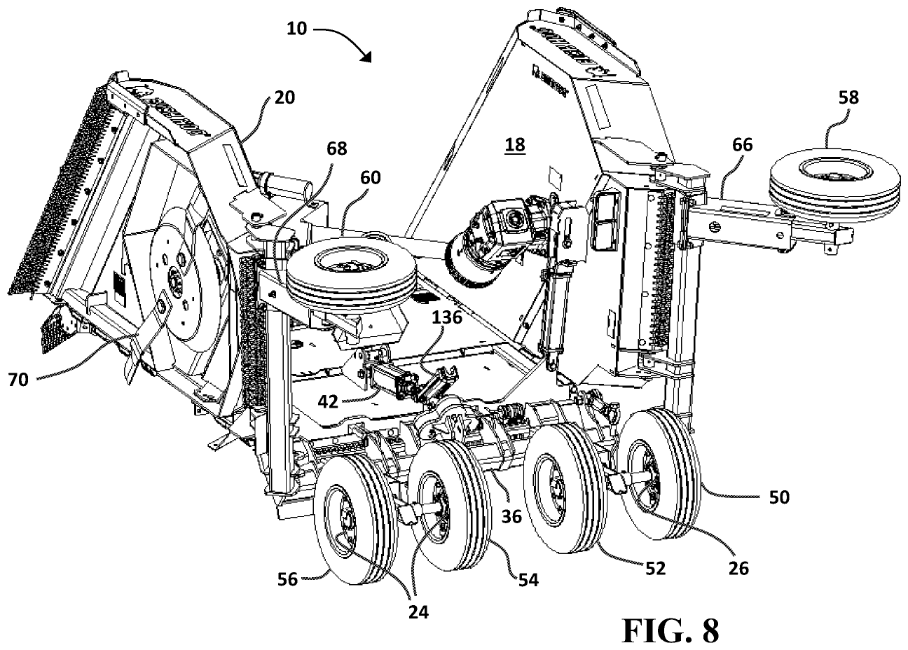

FIG. 1 shows a top plan view of an exemplary embodiment of a flex-wing rotary cutter 10 (sometimes herein referred to as cutter 10) hitched to a towing vehicle 12, such as a tractor, for example. FIG. 2 is a perspective view of flex-wing rotary cutter 10 unhitched from the towing vehicle 12. As shown in FIG. 1 and FIG. 2, flex-wing rotary cutter 10 may include a central deck 14. Central deck 14 may be connected to one or more of a right-side deck 18 and a left-side deck 20. For example, right-side deck 18 may be connected to the central deck 14 via a first hinge 32, and left-side deck 20 may be connected to the central deck 14 via a second hinge 34. One or more cutting elements may be disposed underneath each of central deck 14, right-side deck 18, and left-side deck 20. For example, in some embodiments, a rotating blade 70 (see FIG. 8) may be connected to left-side deck 20. Similarly, a rotating blade 70 may be connected to each of central deck 14 and right-side deck 18.

Flex-wing rotary cutter 10 may be configured for being pulled via a hitch member 22 over terrain on a plurality of ground wheels, which may include left and right pairs of central tandem wheels 24 and 26 and left and right outer wing wheels 28 and 30, for example. Generally, the wheels 24, 26, 28, 30 may include rubber tires mounted thereto. However, in some embodiments, other types of wheels 24, 26, 28, 30 may be used. For example, as shown in FIG. 1 and FIG. 2, tires 50, 52, 54, and 56 may be mounted to the central tandem wheels 24 and 26. Tires 60 and 58 may be mounted, respectively, to the outer wing wheels 28, 30. Central tandem wheels 24, 26 may be mounted to a central axle 36. For example, tandem wheels 24 may be mounted to the central axle 36 through a first central axle arm 62. Tandem wheels 26 may be mounted to the central axle 36 through second central axle arm 64. Although tandem wheels 24, 26 are shown in FIG. 1 and FIG. 2, other configurations are possible. For example, in some embodiments, each of the first central axle arm 62 and the second central axle arm 64 may include a single wheel with a single tire connected thereto. Outer wing wheel 30 may be mounted to right-side axle 40 through right-side axle arm 66. Likewise, outer wing wheel 28 may be mounted to left-side axle 38 through left-side axle arm 68. In some embodiments, each of the axle arms 62, 64, 66, 68 may include a unitary or tandem wheel mounted thereto and at least one tire.

Flex-wing rotary cutter 10 may include a suspension system configured to dampen the up and down motion caused by collisions between the tires and ground obstacles thereby providing a more even cut and reducing high shock loads being transmitted to the cutter 10 and towing vehicle 12. For example, in some embodiments, flex-wing rotary cutter 10 may include the exemplary suspension system 100 (shown in FIG. 1 and FIG. 2). The suspension system 100 may include separate suspension assemblies 80, 82, 84, 86 positioned, respectively, between each of the plurality of wheels 30, 26, 24, 28 and an associated axle upon which a given wheel is mounted. The suspension system 100 may further include a central suspension assembly 72 connecting the central deck 14 and the central axle 36. In some embodiments, the suspension system 100 may provide significantly improved impact load distribution thereby providing a much-improved experience for an operator as compared with some other systems including only suspension assemblies coupled to individual wheels or only a central suspension assembly. Importantly, the suspension system 100 may, in some embodiments, provide improved impact load distribution without compromising (or in some instances significantly improving) the cutter's stability when the cutter 10 is being towed in a transport configuration (see FIG. 8) over uneven ground thereby solving problems associated with transport stability for some flex-wing rotary cutters.

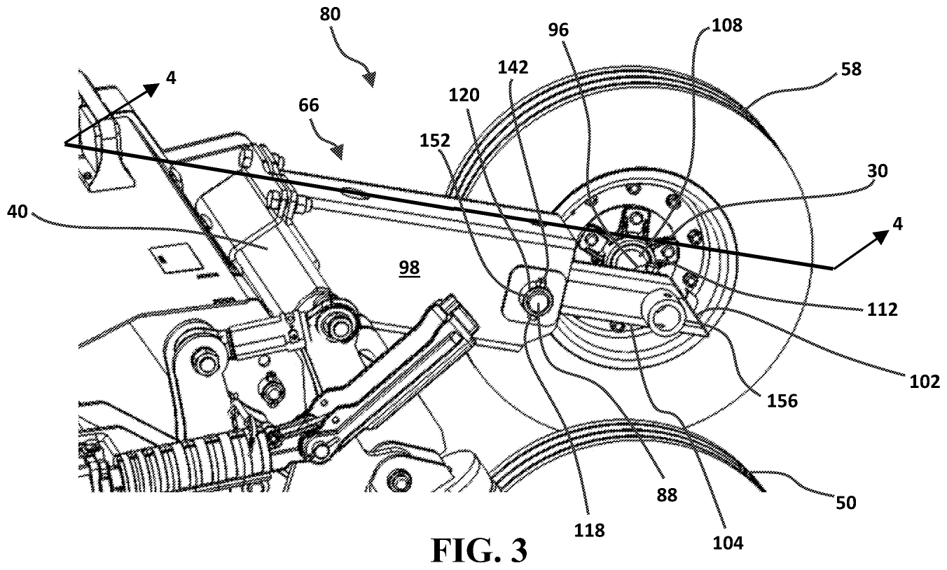

In some embodiments, one or more of the suspension assemblies 80, 82, 84, 86 may include a lever arm or suspension bar that is pivotably mounted to an axle arm connecting a given wheel of the flex-wing cutter 10 to its associated axle. For example, an exemplary embodiment of the suspension assembly 80 including a lever arm in the form of a pivotably mounted suspension bar 104 is shown in FIGS. 3-5. Suspension assembly 80 may be connected to the right-side axle arm 66 and may be configured to reduce impact loads transmitted from the wheel 30 to the right-side axle 40. Likewise, suspension assemblies 82, 84, and 86 may, respectively, be connected to the axle arms 64, 62, and 68 in a similar manner. The suspension assemblies 80, 82, 84, 86 may be configured to reduce impact loads transmitted from their respective wheels 30, 26, 24, 28 to the axle upon which the wheel is connected.

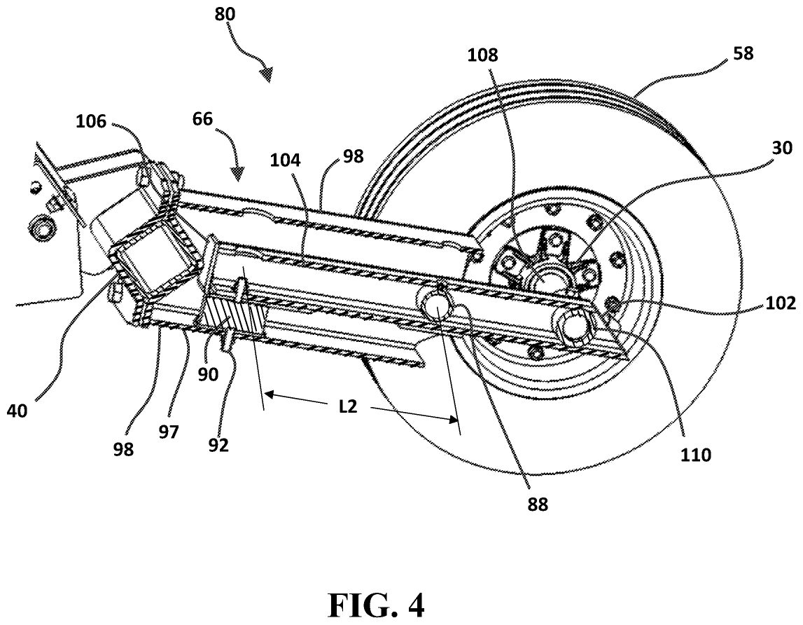

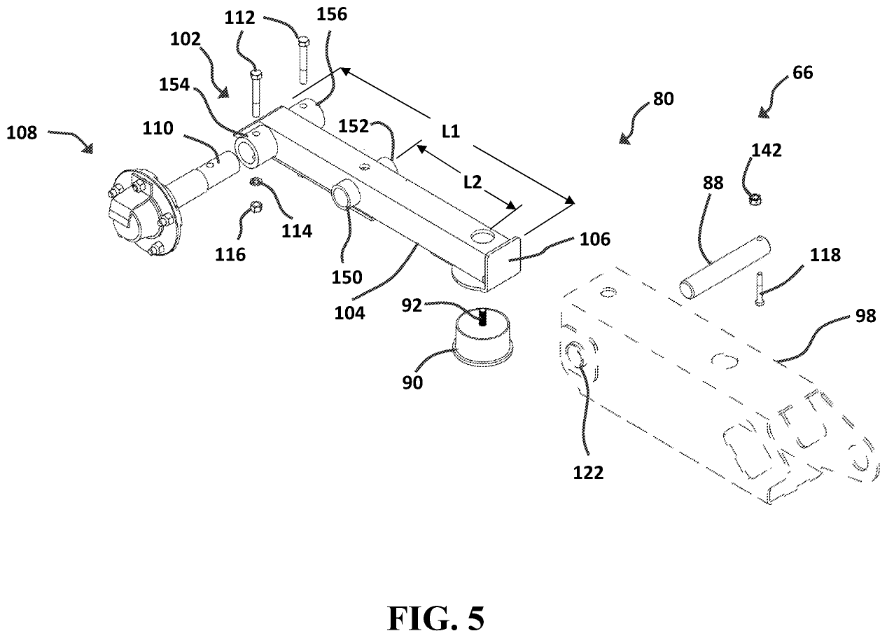

FIG. 3 is a detailed perspective view of right-side axle arm 66 showing how it connects the wheel 30 to the right-side axle 40 and further showing an exemplary embodiment of the suspension assembly 80 mounted therein. FIG. 4 shows a cross-sectional view of the right-side axle arm 66 taken at section 4-4 shown in FIG. 3. FIG. 5 is a perspective exploded view of the right-side axle arm 66. As shown in FIGS. 3-5, the suspension assembly 80 may include a pivotably mounted suspension bar 104. At least one end of the suspension bar 104 may be mounted so as to resist rotation of the suspension bar 104 about its pivot (see pivot pin 88, shown in FIGS. 3-5). For example, as shown in FIG. 4, the suspension bar 104 may be mounted so that a first end 106 of the suspension bar is engaged with a suspension component 90. In some embodiments, suspension component 90 may be any suitable component that resists rotation of the suspension bar 104 with respect to the axle arm 66, including, for example, a coiled spring or a body of an elastic material. In this disclosure, a suspension component in the form of a body of an elastic material may sometimes be referred to as an isolator. For example, a suspension component made of an elastomeric rubber may sometimes herein be referred to as a rubber isolator. The suspension bar 104 may, for example, be in the form of a tube or a rod.

In some embodiments, the suspension bar 104 may include one or more protruding collars 150, 152, 154, 156 (see FIG. 3 and FIG. 5). The collars 150, 152, 154, 156 may, for example, function as bosses guiding connection and alignment of structure to which the suspension bar 104 may be mounted. The collars 150, 152, 154, 156 may also be configured to provide strength and mounting stability. In some embodiments, one or more of the collars 150, 152, 154, 156 may be integral to the suspension bar 104 or fixedly connected to the suspension bar 104 via one or more weldments. Alternatively, one or more of the collars 150, 152, 154, 156 may be connected to the suspension bar 104 in some other suitable way, such as using bolts or rivets, for example. Suspension bar 104 may be mounted so as to position a second end 102 of the suspension bar 104 at a position nearby or adjacent to the wheel 30. For example, in some embodiments, as shown in FIGS. 3-5, the second end 102 of the suspension bar 104 may be secured to wheel hub assembly 108. For example, a stationary portion or stator 110 of the wheel hub assembly 108 may be aligned to the collar 154 of the suspension bar 104 and secured thereto via one or more hex head capscrews 112 and associated connectors 114, 116, such as locknuts and washers, for example. Collar 156 may be used for mounting wheels of a tandem configuration. Thus, collar 156 may or may not be used for a given wheel or may be omitted from some suspension bars 104.

The suspension bar 104 may be mounted so as to position its first end 106 at a position nearby or adjacent to right-side axle 40. For example, as shown in FIG. 4, the first end 106 of the suspension bar 104 may be mounted at a position generally towards the axle end 97 (see FIG. 4) of a housing 98 of right-side axle arm 66. As shown therein, in some embodiments, the suspension bar 104 may be mounted at or near the axle end 97 of the housing 98 via the suspension component 90 and a connection pin 92. Thus, with the second end 102 of the suspension bar 104 positioned nearby or adjacent to the wheel 30 and the first end 106 of the suspension bar 104 positioned nearby or adjacent to the right-side axle 40, the suspension bar 104 may extend over substantially the full length of the right-side axle arm 66.

As shown in FIGS. 3-5, suspension bar 104 may be pivotably connected to right-side axle arm 66. For example, in some embodiments, the suspension bar 104 may be pivotably mounted to the housing 98 of right-side axle arm 66 via a pivot pin 88 (see FIGS. 3-5). Pivot pin 88 may, for example, be inserted through openings 120, 122 (shown in FIG. 3 & FIG. 5, respectively) formed in the housing 98 of right-side axle arm 66 and through collars 150, 152 (see FIG. 5), which may be aligned with the openings 120, 122, and connected, respectively, on the left side and right side of the suspension bar 104. The pivot pin 88 may, for example, be secured in place using a cap screw 118 and locknut 142 or using some other suitable connector.

In some embodiments, the suspension bar 104 may extend over substantially the full length of the right-side axle arm 66. This may, for example, allow for use of a relatively long moment arm L2 (see FIG. 4 and FIG. 5) between the pivot pin 88 and the suspension component 90. By taking advantage of a longer moment arm L2, a softer suspension component (e.g., an isolator of lower durometer hardness) may be used yet still allow for support of the required weight of the cutter 10 during use. In some embodiments, the suspension bar 104 may have a length L1 (see FIG. 5) that is between about 20 inches to about 30 inches. In some embodiments, the moment arm L2 (see FIG. 4 and FIG. 5) corresponding to the length between the pivot pin 88 and the suspension component 90 may be about 10 inches to about 15 inches.

In some embodiments, each of the additional suspension assemblies 82, 84, 86 may be similarly configured. For example, generally, suspension assembly 86 may be configured the same as suspension assembly 80 so that the two outward facing axle arms (e.g., right-side axle arm 66 and left-side axle arm 68) are configured substantially equivalently. Likewise, in some embodiments, suspension assemblies 82, 84 may be similarly configured to suspension assemblies 80, 86. However, in some embodiments, suspension components 90 used with the two central axle arms (e.g., first central axle arm 62 and second central axle arm 64) may be configured differently than suspension components 90 used with the outward facing axle arms (e.g., right-side axle arm 66 and left-side axle arm 68). For example, in some embodiments, each of the suspension components 90 used in different axle arms 62, 64, 66, 68 may comprise an elastic body of material such as a rubber isolator. Materials used in the central axle arms 62, 64 may be of different hardness than those used in the outward facing axle arms 66, 68. For example, the hardness of materials used in different suspension components 90 in each of the axle arms 62, 64, 66, and 68 may be adjusted to accommodate for different weights of the relevant decks 14, 18, 20 connected thereto. In some embodiments, the hardness of a first material used in the suspension components in each of the axle arms 62, 64 may be greater than is the hardness of a second material used in the suspension components in at least one of the axle arms 66, 68. For example, the first material may be a material of between about 25 Shore A hardness and about 60 Shore A hardness. The second material may be a material that is between about 10% to about 50% lesser in hardness than is the first material.

As described above for suspension assembly 80, the other suspension assemblies 82, 84, 86 may also include a pivotably mounted suspension bar 104. For example, a suspension bar 104 may be mounted within each of first central axle arm 62 and second central axle arm 64. The suspension bar 104 may be mounted so as to engage with a corresponding suspension component 90. The suspension bar 104 may further, in some embodiments, be mounted so as to extend over substantially the full length of its associated axle arm 62, 64. While generally increasing shock load absorption, such configurations may allow for increased travel of wheels when moving over ground obstacles increasing risk of rollover, for example. This risk may be augmented by the increased weight supported by the wheels 24, 26 of the central axle arms 62, 64 (which support the full weight of the decks 14, 18, 20 when the cutter 10 is configured in a transport configuration). In some embodiments, this constraint may be balanced by central suspension assembly 72. For example, central suspension assembly 72 may help to buffer the central deck 14 and the associated side decks 18, 20 supported thereon in the transport configuration from ground obstacle induced oscillations and help to keep the center of mass of the cutter 10 substantially centered between the outer tires 50, 56.

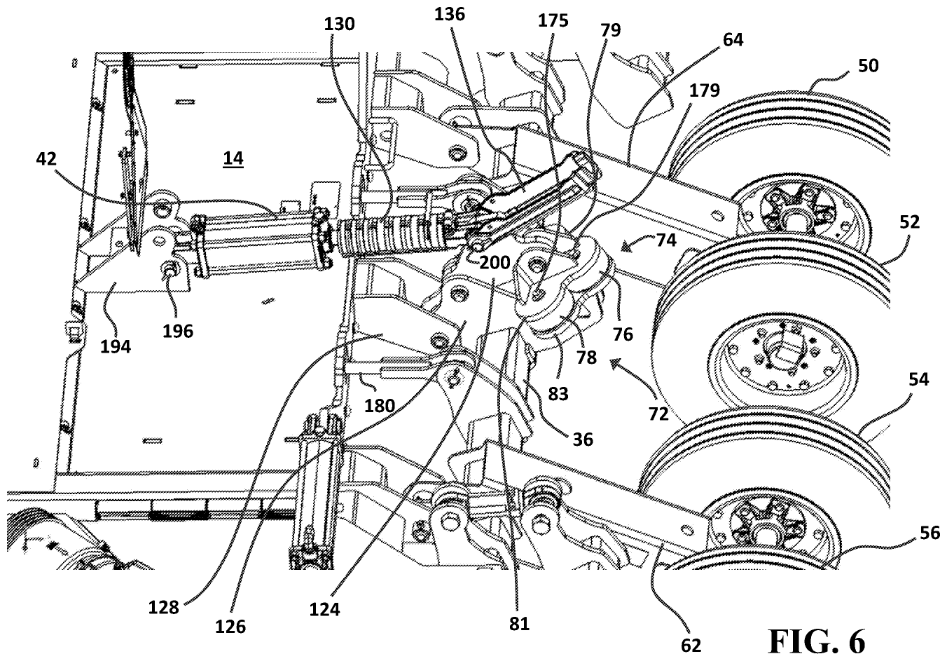

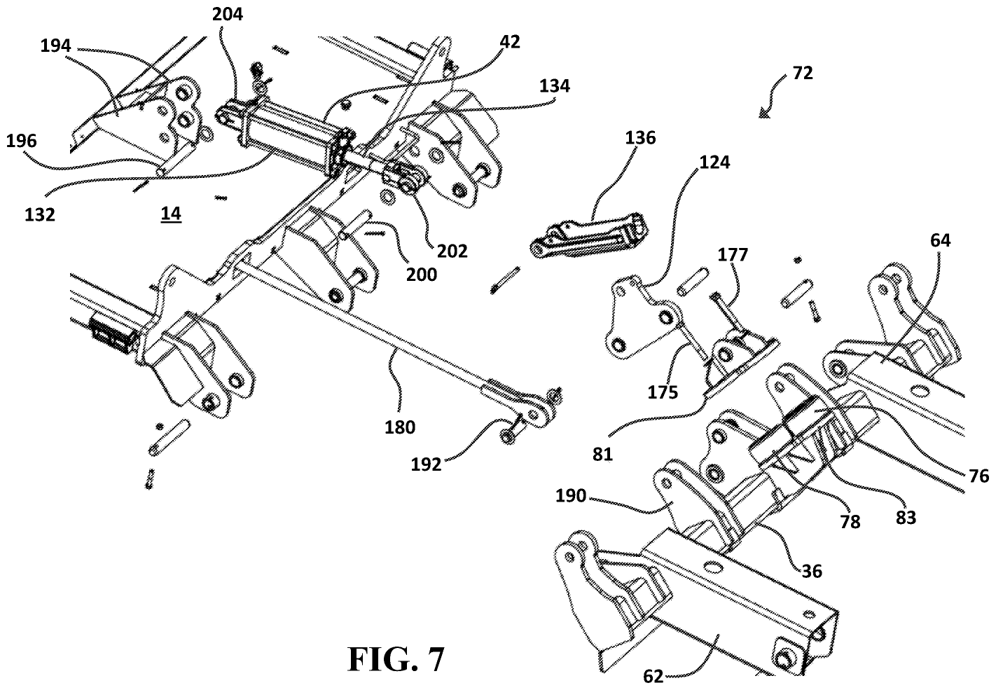

An exemplary embodiment of central suspension assembly 72 is shown in FIG. 6 and FIG. 7. FIG. 6 is a detailed perspective view of a part of flex-wing rotary cutter 10 showing an exemplary embodiment of the suspension assembly 72. FIG. 7 is an exploded perspective view of suspension assembly 72 and surrounding elements of the cutter 10. Central suspension assembly 72 may, for example, include one or more suspension components positioned between the central deck 14 and the central axle 36. In some embodiments, central suspension assembly 72 may include a bank 74 (sometimes referred to herein as suspension bank 74) of suspension components 76, 78, 79. For example, a group of three suspension components 76, 78, 79 may make up the suspension bank 74. However, in some embodiments, some other number of suspension components, including, for example, between about two to about eight suspension components may make up the suspension bank 74. In some embodiments, central suspension assembly 72 may include a single suspension component in the form of a rubber isolator.

In some embodiments, suspension bank 74 may include at least one rubber isolator. The suspension bank 74 may be configured to help prevent excessive tilting of the central cutter deck 14 and/or other components of flex-wing rotary cutter 10 connected thereto when respective ground wheels 24, 26 encounter obstacles that might otherwise shift the position of the central cutter deck 14 and components connected thereto and significantly shift the center of gravity of the rotary cutter 10. For example, in some embodiments, as shown in FIG. 6, all three of the suspension components 76, 78, 79 may be rubber isolators made of a relatively high stiffness material. The hardness of an isolator material may, for example, be measured according to one or more industry standards, including those designated under DIN 53505 (ISO 868).

For example, in some embodiments, each of the suspension components 76, 78, 79 may be made of a rubber material of about 75 Shore A hardness. In some embodiments, the hardness of the material used for each of the suspension components 76, 78, 79 may be between about 50 Shore A hardness and about 100 Shore A hardness. The suspension components 76, 78, 79 may, for example, be greater in hardness than a corresponding hardness used for suspension assemblies positioned between the wheels of a flex-wing rotary cutter and its associated axles. For example, in some embodiments, suspension component 90 may be made of a material of between about 25 Shore A hardness and about 60 Shore A hardness. In some embodiments, the suspension components 76, 78, 79 may be made of a material having a durometer hardness that is at least about 1.25× to about 2.0× the hardness of a material used for suspension component 90.

In some embodiments, the respective suspension components 76, 78, 79 of suspension bank 74 may be held in place using a pair of mounting plates. For example, as shown in FIG. 6 and FIG. 7, the suspension components 76, 78, 79 may be sandwiched between a first mounting plate 81 and a second mounting plate 83. The suspension components 76, 78, 79 may, for example, be held in place with respective pins 179, 175, 177. Suspension bank 74 may be connected to central deck 14 through a connecting bracket 124 and an actuator 42. The actuator 42 may, for example, be a hydraulic cylinder. As shown in FIG. 7, actuator 42 may include a body 132 and an extendable and retractable piston 134. In FIG. 6, the piston 134 is hidden underneath a protective sheath 130. Loads applied on central axle 36 may, generally, be transmitted through suspension bank 74 to the central deck 14 through connecting bracket 124 and actuator 42. Actuator 42 may, for example, be connected to the suspension bank 74 via the connecting bracket 124, which may, for example, be secured to a first end 202 of actuator 42 via a connecting pin 200. A second end 204 of actuator 42 may be connected to the central deck 14 via one or more connecting brackets 194 and an associated connecting pin 196, for example. In some embodiments, a cast transfer lock 136 may be coupled to the actuator 42. Cast transfer lock 136 may be rotated to a position engaging the body of actuator 42. This may be particularly used when the cutter 10 is moved to a transport condition (see FIG. 8) so that impact loads are not transmitted from the central axle 36 to the piston 134 during transport.

As shown in FIG. 7, in some embodiments, flex-wing rotary cutter 10 may include one or more leveling rods 180. The one or more leveling rods 180 may, for example, be connected at a first end to the central axle 36. For example, a first end of the one or more leveling rods 180 may be connected to the central axle 36 through one or more connecting brackets 190 via one or more pins 192. A second end (not shown) of the one or more leveling rods 180 may, for example, be connected to the draft tongue of the cutter 10. The one or more leveling rods 180 may help to align the central axle 36 with respect to the ground. Thus, the one or more leveling rods 180 may also help ensure that the central deck 14 is oriented generally parallel to the ground so as to help ensure an even cut.

As shown in FIG. 8, flex-wing rotary cutter 10 may be oriented to a transport configuration. For example, in the transport configuration shown in FIG. 8, each of the right-side deck 18 and the left-side deck 20 may be folded upwards into a substantially vertical configuration. For example, respective actuators 170, 172 (see also FIG. 1) may be used to orient the right-side deck 18 and the left-side deck 20 to the folded transport configuration. In this configuration, only the left and right pairs of central tandem wheels 24 and 26 are left in contact with the ground. Generally, in the transport configuration, flex-wing rotary cutter 10 may also be adjusted so that central axle 36 is rotated so as to raise the position of central deck 14. For example, actuator 42 may be extended so that the central axle 36 is rotated in a direction so that the central deck 14 is shifted upwards. For example, as shown in FIG. 6, rotation of the central axle 36 initiates rotation of respective brackets 124, 126 with respect to bracket 128 (which may be fixed to central deck 14) so as to push the central deck 14 upwards, and leveling rod 180 may be used to orient central deck 14 generally parallel to the ground as describe above. In this configuration, the central deck 14 has relatively high clearance of ground obstacles as is generally desired during transport of the cutter 10.

Folding of the right-side deck 18 and the left-side deck 20 and raising the central deck 14 (to achieve better ground clearance) may raise the center of gravity of flex-wing rotary cutter 10. If the cutter 10 is being transported on a hillside, the higher center of gravity may tend to cause the cutter 10 to become unstable. For example, if the suspension allows one wheel to move too much, the center of gravity of the flex-wing rotary cutter 10 may shift so as to increase risk of the cutter 10 rolling over. For this reason, a suspension applied at the wheels may only have relatively minimal travel before becoming unstable. Accordingly, a suspension applied solely at the wheels may generally include relatively high stiffness thereby sacrificing shock load reduction so as to maintain stability during transport.

In some embodiments herein, a central suspension assembly 72 may be used in conjunction with wheel assembly suspensions so as to increase stability of the cutter 10. Use of a central suspension assembly 72 in combination with wheel suspensions may, for example, allow for use of a relatively stiffer isolator at each of the wheel suspensions than might otherwise be used without central suspension assembly 72 (for the sake of anti-rollover stability) yet still provide significant shock load reduction. For example, a relatively stiff isolator 90 may be used in the suspension assemblies 82, 84 so as to minimize excessive relative motion between the central tandem wheels 24, 26 (which may cause instability), and any related loss of shock absorbance may be compensated for using the central suspension assembly 72. Expansion and contraction of the central suspension assembly 72 may be achieved without providing for significant relative movement between the left and right pairs of central tandem wheels 24 and 26 so that shock loads absorbed by the central suspension assembly 72 will not significantly shift the center of gravity of the flex-wing rotary cutter 10.

For example, in one series of tests, a flex-wing rotary cutter, as described above, was made and tested for shock load reduction. The flex-wing rotary cutter (or test cutter) included a plurality of suspension assemblies 80, 82, 84, 86 coupled to each of four associated axle arms 66, 64, 62, and 68. Each of the suspension assemblies 80, 82, 84, 86 included a suspension bar 104 operatively engaged to a suspension component 90. In this example, the suspension component 90 was embodied in the form of a rubber isolator made from a material with a durometer hardness of about 40A Shore. A central suspension assembly 72 was positioned between a central axle 36 and the central cutting deck 14. The suspension assembly 72 was made of a bank of four equivalent rubber isolators each of which was made of a material of durometer hardness of about 75A Shore. An accelerometer was mounted to the central cutting deck. For comparison, an existing model of a flex-wing rotary cutter (referred to herein as the control cutter) of similar size and weight to flex-wing rotary cutter 10 was mounted with a similarly positioned accelerometer. The control cutter included individual wheel suspensions at each of four axle arms but did not have a central suspension assembly. The two flex-wing rotary cutters were driven in multiple passes over a test area. As generally understood in the art, acceleration of the central deck is related to the shock load applied on the central deck during operation. Accelerometer data was converted to a g-force value realized on the central cutter deck, with the resultant data summarized in Table 1.

TABLE 1
Accelerometer data for the Control & Test Cutters

| | Pass Number (Vertical g-Force) | | | | | | | | | |
|---|---|---|---|---|---|---|---|---|---|---|
| | 1 | 2 | 3 | 4 | 5 | 6 | 7 | 8 | 9 | 10 |
| Control | 7.53 | 7.39 | 9.75 | 6.61 | 7.28 | 7.67 | 7.98 | 7.75 | 7.68 | 7.35 |
| Cutter | | | | | | | | | | |
| Test | 3.66 | 4.06 | 3.84 | 3.73 | 3.82 | 3.87 | 3.73 | 3.80 | 3.94 | 3.65 |
| Cutter | | | | | | | | | | |

As shown in Table 1, the central cutting deck of the control cutter was subject to a substantially greater g-force than was the central cutting deck of the test cutter (rms average g-forces of 7.7 and 3.8, respectively). Moreover, the g-force realized on the test cutter was not only much lower than the corresponding g-force realized on the control cutter, but also more reproducible than for the control. Thus, embodiments of rotary cutters with dual suspension assemblies as described herein (that is, including both a central suspension assembly and an axle arm suspension assembly at each wheel) may significantly reduce the dynamic impact loads on the cutter due to ground/wheel interaction.

Although the foregoing specific details describe certain embodiments of this invention, persons of ordinary skill in the art will recognize that various changes may be made in the details of this invention without departing from the spirit and scope of the invention as defined in the appended claims and other claims that may be drawn to this invention and considering the doctrine of equivalents. Among other things, any feature described for one embodiment may be used in any other embodiment, and any feature described herein may be used independently or in combination with other features. Also, unless the context indicates otherwise, it should be understood that when a component is described herein as being secured, mounted, connected, or coupled to another component, such may be secured, mounted, connected, or coupled directly with no intermediate components or indirectly with one or more intermediate components. Although flex-wing rotary cutters are described herein, the suspension features described herein may be used with other embodiments. Therefore, it should be understood that this invention is not to be limited to the specific details shown and described herein.

What is claimed is:

1. A flex-wing rotary cutter comprising:
a central deck connected to a central axle;
a first axle arm depending from the central axle;
a first suspension assembly pivotably connected to the first axle arm, the first suspension assembly comprising:
a first suspension bar connected to a first wheel; and
a first suspension component flexibly engaged with the first suspension bar and the first axle arm, the first suspension component being configured to resist rotation of the first suspension bar with respect to the first axle arm;
a second axle arm depending from the central axle;
a second suspension assembly pivotably connected to the second axle arm, the second suspension assembly comprising:
a second suspension bar connected to a second wheel; and
a second suspension component flexibly engaged with the second suspension bar and the second axle arm, the second suspension component being configured to resist rotation of the second suspension bar with respect to the second axle arm;
a side deck hingedly connected to the central deck and also connected to a side axle;
a third axle arm depending from the side axle;
a third suspension assembly pivotably connected to the third axle arm, the third suspension assembly comprising:
a third suspension bar connected to a third wheel; and
a third suspension component flexibly engaged with the third suspension bar and the third axle arm, the third suspension component being configured to resist rotation of the third suspension bar with respect to the third axle arm;
at least one cutting element operably mounted to each of the central deck and the side deck; and
a central suspension assembly flexibly connected between the central axle and the central deck, the central suspension assembly comprising a fourth suspension component configured to mitigate dynamic loads transmitted from the central axle to the central deck.

2. The flex-wing rotary cutter of claim 1 wherein each of the first suspension bar and the second suspension bar is mounted within a respective one of the first axle arm and the second axle arm so as to extend within about the full length of the respective one of the first axle arm and the second axle arm.

3. The flex-wing rotary cutter of claim 2 wherein each of the first suspension bar and the second suspension bar has a length of about 20 inches to about 30 inches.

4. The flex-wing rotary cutter of claim 1 wherein each of said first suspension component and said second suspension component is made of a first material having a Shore A hardness of between about 25 Shore A hardness and about 60 Shore A hardness.

5. The flex-wing rotary cutter of claim 4 wherein said third suspension component is made of a second material of lesser hardness than said first material.

6. The flex-wing rotary cutter of claim 5 wherein said second material has a Shore A hardness that is between about 10% to about 50% lesser than the Shore A hardness of the first material.

7. The flex-wing rotary cutter of claim 4 wherein said fourth suspension component is made of a second material of between about 50 Shore A hardness and about 100 Shore A hardness.

8. The flex-wing rotary cutter of claim 1 wherein each of said first suspension component, said second suspension component, and said third suspension component is made of a first material of between about 25 Shore A hardness and about 60 Shore A hardness.

9. The flex-wing rotary cutter of claim 8 wherein said fourth suspension component is made of a second material of between about 50 Shore A hardness and about 100 Shore A hardness.

10. The flex-wing rotary cutter of claim 1 wherein each of said first suspension component and said second suspension component comprises a rubber isolator.

11. The flex-wing rotary cutter of claim 1 wherein the central suspension assembly comprises a suspension bank.

12. The flex-wing rotary cutter of claim 11 wherein the suspension bank comprises between about two to about eight isolators.

13. The flex-wing rotary cutter of claim 1 wherein each of the first wheel and the second wheel are tandem wheels.

14. The flex-wing rotary cutter of claim 1 wherein each of the first suspension bar and the second suspension bar comprises a collar configured for receiving a pivot pin.

15. The flex-wing rotary cutter of claim 14 wherein said collar is fixed to the respective one of said first suspension bar and said second suspension bar via a weldment.

16. The flex-wing rotary cutter of claim 1 wherein each of the first suspension bar and the second suspension bar comprises a collar configured for receiving a wheel hub assembly.

17. The flex-wing rotary cutter of claim 1 wherein said first axle arm comprises a first axle arm housing; and
wherein said first suspension component is positioned towards an end of the first axle arm housing adjacent to the central axle, the first suspension component being sandwiched between the first suspension bar and the first axle arm housing.

18. The flex-wing rotary cutter of claim 17 wherein said second axle arm comprises a second axle arm housing; and
wherein said second suspension component is positioned towards an end of the second axle arm housing adjacent to the central axle, the second suspension component being sandwiched between the second suspension bar and the second axle arm housing.

19. The flex-wing rotary cutter of claim 1 wherein the side deck is a member of a pair of side decks including a right-side deck and a left-side deck.

20. A rotary cutter comprising:
a central deck having a rotary cutting element;
a central axle rotatably mounted to the central deck;
a plurality of axle arms depending from the central axle;
a plurality of suspension bars pivotably mounted to respective ones of the plurality of axle arms;
a plurality of wheels respectively mounted to the plurality of suspension bars;
a plurality of suspension components respectively engaged with respective ones of the plurality of axle arms and the plurality of suspension bars such that each of the plurality of suspension components is configured to resist rotation of the respective suspension bar with respect to the respective axle arm; and
a central suspension assembly comprising a central suspension component configured to resist rotation of the central axle with respect to the central deck.

21. The rotary cutter of claim 20 further comprising a pair of side decks including a left-side deck and a right-side deck, each of the left-side deck and the right-side deck hingedly connected to the central deck.

22. The rotary cutter of claim 20 wherein each of said plurality of suspension components is made of a first material of between about 25 Shore A hardness and about 60 Shore A hardness.

23. The rotary cutter of claim 22 wherein the central suspension component is made of a second material of between about 50 Shore A hardness and about 100 Shore A hardness.

24. The rotary cutter of claim 20 wherein the central suspension assembly comprises a suspension bank.

25. The rotary cutter of claim 24 wherein the suspension bank comprises between about two to about eight isolators.
